(19) United States
(12) Patent Application Publication
(10) Pub. No.: US 2015/0109093 A1
(43) Pub. Date: Apr. 23, 2015

(54) VARIABLE RESISTANCE ELEMENT

(71) Applicants: MICRON MEMORY JAPAN, INC., Tokyo (JP); SHARP KABUSHIKI KAISHA, Osaka (JP)

(72) Inventors: Naoya HIGANO, Tokyo (JP); Yukio TAMAI, Osaka-shi (JP); Suguru KAWABATA, Osaka-shi (JP)

(21) Appl. No.: 14/516,745

(22) Filed: Oct. 17, 2014

(30) Foreign Application Priority Data
Oct. 22, 2013 (JP) 2013-218949

(51) Int. Cl. H01C 7/10; H01C 1/144

(52) U.S. Cl. CPC H01C 7/10; H01C 1/144
USPC 338/20

(57) ABSTRACT

With miniaturization of a variable resistance element, it is becoming difficult to suppress the adverse effect CMP or etching might have on the resistance variable element. There is proposed a variable resistance element comprising an insulation film and a lower electrode equipped with a first portion surrounded by the insulation film and a columnar-shaped second portion protruded upwards from the first portion beyond an upper surface of the insulation film. The variable resistance element also comprises a variable resistance film that covers a preset region of the insulation film, the present region including the lower electrode, and that is electrically connected to at least an upper surface of the second portion of the lower electrode. The variable resistance element further comprises an upper electrode that covers the variable resistance film and that is electrically connected to the variable resistance film.

### TECHNICAL FIELD

### Reference to Related Application

This application is based upon and claims the benefit of the priority of Japanese patent application No. 2013-218949, filed on Oct. 22, 2013, the disclosure of which is incorporated herein in its entirety by reference thereto.

This invention relates to a variable resistance element.

### BACKGROUND

There is known a variable resistance element which is responsive to a voltage applied thereto (or a current caused to flow therein) to change its own resistance value. The variable resistance element, having its resistance reversibly changed depending on the voltage applied, is capable of non-volatilely storing data corresponding to the resistance value, and hence is used in a non-volatile semiconductor memory, such as ReRAM (Resistance Random Access Memory).

In general, the variable resistance element has a MIM (Metal-Insulator-Metal) structure in which a lower electrode, a variable resistance film and an upper electrode are stacked together. It is manufactured by forming a variable resistance film (variable resistance material) on the lower electrode and forming the upper electrode on the variable resistance film. The variable resistance film may be prepared by depositing the variable resistance film on the lower electrode and thereafter smoothing an upper surface of the variable resistance material by CMP (Chemical Mechanical Polishing) as in Patent Literature 1, or etching the surface. However, working the variable resistance film by CMP or by etching gives rise to such difficulties that the worked film surface is deteriorated or the resistance of the variable resistance element is not optimum. In addition, the variable resistance film is damaged sporadically, thus causing the characteristics of the elements to be sporadically changed, the operation being then non-stable or non-reliable. In this consideration, it has been proposed in Patent Literature 2 to provide a resistance variable element and an upper electrode on the lower electrode disposed within a contact hole and not to allow the variable resistance film to be exposed to outside at the time of CMP as far as is possible, thereby producing a variable resistance element in a manner free from deterioration.

### Patent Literature 1:

JP Patent Kokai Publication No. JP2004-128468A

### Patent Literature 2:

WO2007/102341A1 pamphlet

### SUMMARY

The following analysis is given by the present invention.

However, with miniaturization of the variable resistance element, the area of the variable resistance element operating as the resistance variable portion is diminishing. Thus, the technique of not allowing the variable resistance film to be exposed to outside as far as is possible by itself may not be sufficient to suppress the adverse effects of CMP or etching on the variable resistance film.

In one aspect, there is provided a variable resistance element including an insulation film and a lower electrode equipped with a first portion surrounded by the insulation film and a columnar-shaped second portion protruded upwards beyond an upper surface of the insulation film. The variable resistance element also includes a variable resistance film that covers a preset region of the insulation film, the present region including the lower electrode, and that is electrically connected to at least an upper surface of the second portion of the lower electrode, and an upper electrode that covers the variable resistance film and that is electrically connected to the variable resistance film.

The meritorious effects of the present invention are summarized as follows without limitation. According to the one aspect, a variable resistance portion and an etched portion of the variable resistance element may be set apart a sufficient distance from each other to render it possible to suppress adverse effects of CMP or etching on the variable resistance film.

### BRIEF DESCRIPTION OF THE DRAWINGS

FIG. 1 is a plan view schematically showing a configuration of a variable resistance element according to exemplary embodiment 1.

FIG. 2 shows a cross-section along line X-X′ and a cross-section along line Y-Y′ in FIG. 1, each of which schematically shows the configuration of the variable resistance element according to exemplary embodiment 1.

FIG. 3 is a block diagram schematically showing an example circuit configuration of a semiconductor memory including memory cells each of which is equipped with the variable resistance element according to exemplary embodiment 1.

FIG. 4 is a schematic circuit diagram showing an example configuration of a memory cell array in a semiconductor memory including memory cells each of which is equipped with the variable resistance element according to exemplary embodiment 1.

FIG. 5A, FIG. 5B and FIG. 5C are cross-sectional views, taken along line X-X′ in FIG. 1, schematically showing respective process steps of the manufacturing method for the variable resistance element according to exemplary embodiment 1.

FIG. 6A, FIG. 6B and FIG. 6C, consecutive to FIG. 5A, FIG. 5B and FIG. 5C, are cross-sectional views schematically showing respective process steps of the manufacturing method for the variable resistance element according to exemplary embodiment 1.

FIG. 7 is a plan view schematically showing a configuration of a variable resistance element according to exemplary embodiment 2.

FIG. 8 shows a cross-section along line X-X′, and a cross-section along line Y-Y′ in FIG. 7, each of which schematically shows the configuration of the variable resistance element according to exemplary embodiment 2.

FIG. 9A and FIG. 9B are cross-sectional views, taken along lines X-X′ of FIG. 7, and schematically showing the configuration of a manufacturing method for the variable resistance element according to exemplary embodiment 2.

FIG. 10 is a plan view schematically showing a configuration of a variable resistance element according to a comparative example.

FIG. 11 shows a cross-section along line X-X′, and a cross-section along line Y-Y′ in FIG. 10, each of which schematically shows the configuration of the variable resistance element according to the comparative example.

FIG. 12 is a TEM image of a variable resistance element according to a comparative example tentatively manufactured by TEG.

FIG. 13 is a tabulated view illustrating the atomic compositions (%) of Hf and O by EDX at positions 8 to 14 of the variable resistance film (HfOₓ) of FIG. 12 in the variable resistance element of the comparative example as well as the content ratio (O/F).

FIG. 14 is a graph showing the relationship among the diameters of the lower electrodes, line widths of the variable resistance films as well as the upper electrodes of the variable resistance elements of the comparative example, and the forming voltage.

FIG. 15 is a graph showing the relationship between the diameters of the lower electrodes of the variable resistance elements of the comparative example and the forming voltage.

FIG. 16 is a plan view schematically showing a configuration of a variable resistance element according to exemplary embodiment 3.

FIG. 17 shows a cross-section along line X-X′, and a cross-section along line Y-Y′ in FIG. 16, each of which schematically shows the configuration of the variable resistance element according to exemplary embodiment 3.

FIG. 18A, FIG. 18B and FIG. 18C are cross-sectional views, taken along line X-X′ in FIG. 16, schematically showing respective process steps of the manufacturing method for the variable resistance element according to exemplary embodiment 3.

FIG. 19A, FIG. 19B and FIG. 19C, consecutive to FIG. 18A, FIG. 18B and FIG. 18C, are cross-sectional views schematically showing respective process steps of the manufacturing method for the variable resistance element according to exemplary embodiment 3.

### REFERRED MODES

### Exemplary Embodiment 1

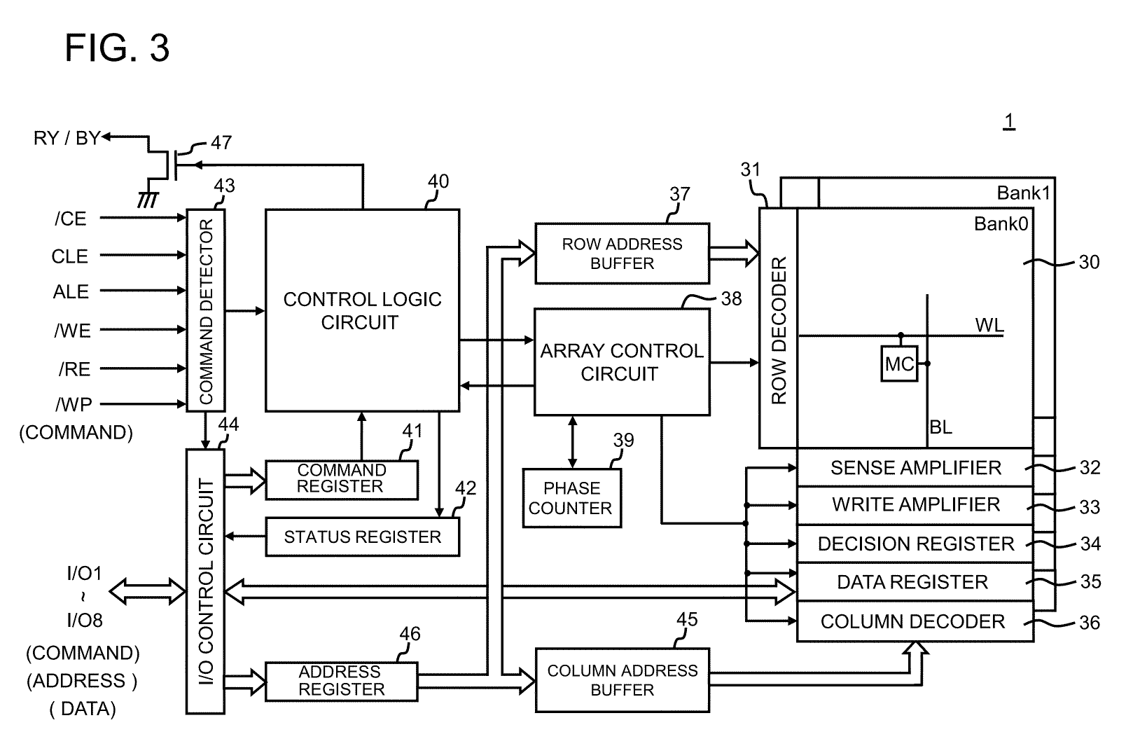

A variable resistance element according to exemplary embodiment 1 will now be described with reference to the drawings. FIG. 3 depicts a block diagram schematically showing an example circuit configuration of a semiconductor memory inclusive of a memory cell equipped with a variable resistance element according to exemplary embodiment 1.

A semiconductor memory 1 is a semiconductor chip equipped with a memory circuit. The semiconductor memory 1 includes, as a memory circuit, a memory cell array 30 made up of a plurality of banks 0 to 1. Each of these banks includes a row decoder 31, a sense amplifier 32, a write amplifier 33, a decision register 34, a data register 35 and a column decoder 36. The semiconductor memory 1 also includes peripheral circuits formed around the rim of the memory circuit. As these peripheral circuits, the semiconductor memory 1 includes a row address buffer 37, an array control circuit 38, a phase counter 39, a control logic circuit 40, a command register 41, a status register 42, a command detector 43, an I/O control circuit 44 and a column address buffer 45. In addition, the semiconductor memory includes an address register 46 and a transistor 47. It is noted that, in the example of FIG. 3, there are provided two banks 0, 1, however, there is no particular limitation to the number of the banks. It is also noted that external power supply voltages VDD, VSS, not shown, are delivered from outside to the semiconductor memory 1.

The memory cell array 30 includes a plurality of memory cells MC arrayed in a plurality of rows and in a plurality of columns. The memory cell array 30 includes a plurality of word lines WL, each extending in one direction, with the word lines WL being arrayed in another direction perpendicular to the one direction, and a plurality of bit lines, each extending in the another direction, with the bit lines being arrayed in the one direction. The memory cell array 30 also includes a plurality of memory cells arranged in the vicinity of points of intersection of the word lines WL and the bit lines BL. The word lines WL are electrically connected to the row decoder 31, while the bit lines BL are electrically connected to the sense amplifier. The memory cell array 30 and the memory cell MC will be detailed subsequently.

The row decoder 31 is responsive to signals from the array control circuit 38 and the row address buffer 37 to activate the relevant word line WL to select a row address in the memory cell array 30 via the so activated word line WL.

The sense amplifier 32 is responsive to a signal from the array control circuit 38 to raise the potential of data read out from the memory cell array 30 via the word line WL. The sense amplifier 32 outputs the data, thus raised in voltage level, to the data register 35 and to the decision register 34.

The write amplifier 33 is responsive to the signal from the array control circuit 38 to raise the potential of the data from the data register 35. The write amplifier 33 outputs the data, thus raised in potential, via the so selected bit line BL to the memory cell array 30 and to the decision register 34.

The decision register 34 is responsive to the signal from the array control circuit 38 to compare write data in the write amplifier 33 to the readout data in the sense amplifier 32 to decide on pass/fail by way of a verifying operation. In case the decision register 34 has detected fail, re-write in the memory cell array 30 is made, and a loop of re-write and readout is carried out until pass of the total of the cells.

The data register 35 is a register that retains data and that exchanges data between itself and the I/O control circuit 44. The data register 35 retains data from the control circuit 44 or the sense amplifier 32. During writing, the data register 35 is responsive to the signal from the array control circuit 38 to output the data retained to the write amplifier 33. During readout, the data register 35 is responsive to the signal from the array control circuit 38 to output the data retained to the I/O control circuit 44.

The column decoder 36 is such a circuit that is responsive to the signals from the array control circuit 38 and from the column address buffer 45 to select a column address in the memory cell array 30 via the bit line BL.

The row address buffer 37 retains row addresses out of the addresses from the address register 46. The row address buffer 37 outputs the row address it is retaining to the row decoder 31.

The array control circuit 38 is responsive to signals from the control logic circuit 40 and the phase counter 39 to control the operations of each of the row decoder 31, sense amplifier 32, write amplifier 33, decision register 34, data register 35 and the column decoder 36. The array control circuit 38 delivers a word line selection signal to the row decoder 31, while supplying a bit line selection signal to the column decoder 36 and supplying a variety of control signals to the sense amplifier 32, write amplifier 33, decision register 34 and the data register 35.

The phase counter 39 is such a counter that controls the phase of accessing subjects in the array control circuit 38.

The control logic circuit 40 outputs a variety of control signals to peripheral circuits. Specifically, the control logic circuit 40 is responsive to signals from the command detector 43 and the command register 41 to output a variety of control signals to the array control circuit 38, status register 42 and the transistor 47. The control logic circuit 40 exchanges signals between itself and the array control circuit 38.

The command register 41 retains a command from the I/O control circuit 44, and outputs the command it is retaining to the control logic circuit 40.

The status register 42 retains a status signal from the control logic circuit 40, and outputs the status signal it is holding to the I/O control circuit 44. It is noted that the status signal is the information showing the status of write pass/write fail or the like.

The command detector 43 is such a circuit that is supplied with commands, such as chip enable /CE, command latch enable CLE, address latch enable /ALE, a write enable /WE, read enable /RE and /WP. The command detector 43 outputs input commands to the control logic circuit 40 and the I/O control circuit 44.

It is noted that /CE is a device selection signal and, if the signal is set to HIGH in the read state, a standby mode is set.

On the other hand, CLE is a signal to control the strobing of a command into the command register 41 within the device. If CLE is set to HIGH at rise or fall time of /WE, data on I/O terminals I/O1 to I/O8 are strobed as commands into the command register 41.

ALE is such a signal that controls strobing the addresses or data into the address register 46 or the data register 35. If, at the rise or fall time of WE, ALE is set to High, data on the I/O terminals I/O1 to I/O8 are strobed as address data into the address register 46. If ALE is set to Low, data on the I/O terminals I/O1 to I/O8 are strobed as input data into the data register 35.

WE/ is a write signal to strobe data from the I/O terminals I/O1 to I/O8 into the inside of the device.

/RE is a signal to output (serially output) data.

/WP is a control signal that inhibits write/erasure to protect data. Usually, /WP=High and, at power up or power down, /AP=Low.

The I/O control circuit 44 is a circuit to control the inputting/outputting of commands, addresses and data. The IO control circuit 44 exchanges commands, addresses and data with outside via the I/O terminals I/O1 to I/O8, and outputs input commands to the command register 41. The I/O control circuit 44 outputs the input address to the address register 46. The I/O control circuit 44 exchanges data with the data register 35, and controls inputting/outputting of commands, addresses and data based on signals from the command detector 43 and the status register 42.

I/O1 to I/O8 are terminals (ports) via which to input/output the commands, addresses and data.

The column address buffer 45 is such a register that retains column addresses out of the addresses from the address register 46. The column address buffer 45 outputs the column addresses it is retaining to the column decoder 36.

The address register 46 is such a register that retains addresses from the I/O control circuit 44. The address register 46 outputs row addresses, out of the addresses it is retaining, to the row address buffer 37, while outputting column addresses, out of the addresses it is retaining, to the column address buffer 45.

The transistor 47 is an NMOS transistor of the open drain configuration. The gate of the transistor 47 is connected to the control logic circuit 40. The source of the transistor 47 is grounded. The drain of the transistor 47 is connected to an output terminal of an inner status notification signal RY/BY. The gate of the transistor 47 is set High during the time the transistor is performing such operations as programming, erasure or reading. The gate of the transistor 47 is turned on (rendered electrically conductive) so that RY/BY=Low (Busy). On completion of the operation, the gate of the transistor is rendered Low so that the RY/BY is pulled up to the power supply potential and hence RY/BY=High (Ready).

It is noted that RY/BY is a signal that notifies an inner status of a device to outside.

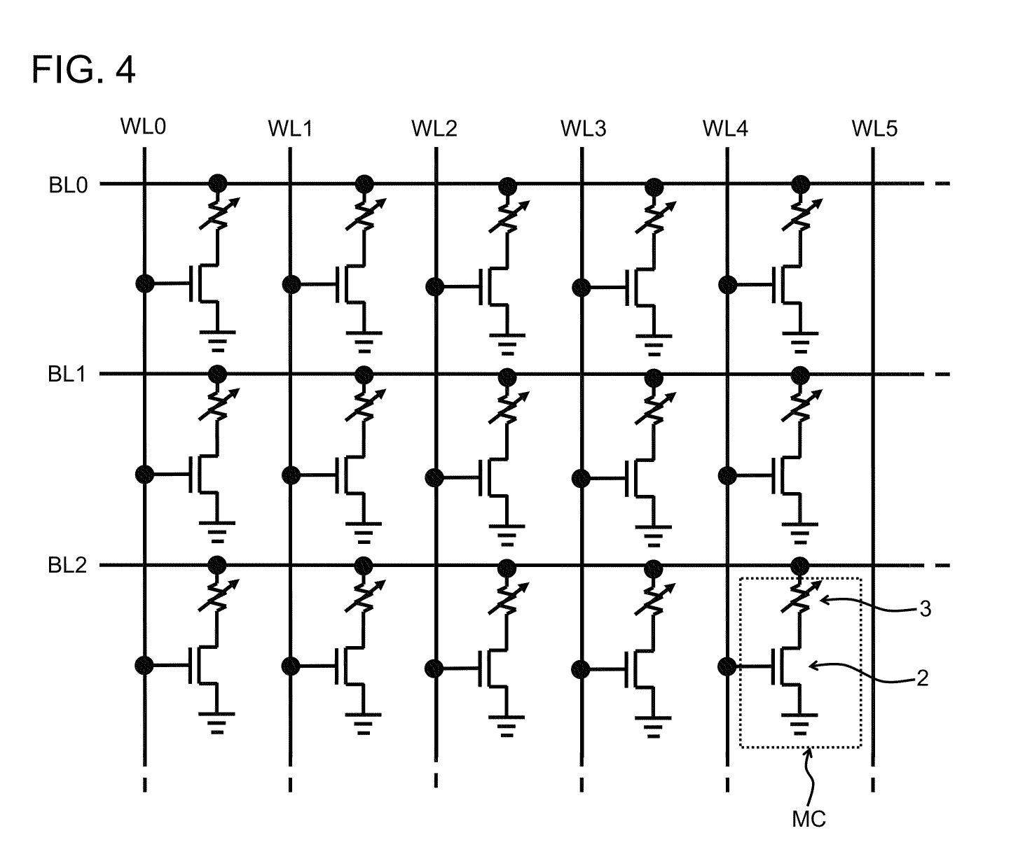

FIG. 4 depicts a circuit diagram schematically showing an example configuration of a memory cell array in a semiconductor memory equipped with a memory cell including a variable resistance element according to exemplary embodiment 1.

The memory cell array (30 of FIG. 3) includes a plurality of word lines (WL of FIG. 3 and WL0 to WL5 in FIG. 4), a plurality of bit lines (BL of FIG. 3 and BL0 to BL2 in FIG. 4) and a plurality of memory cells MC arranged in the vicinity of the points of intersection of the word and bit lines. The word lines are extending in one direction and arrayed in another direction perpendicular to the one direction, while the bit lines are extending in the another direction and arrayed in the above mentioned one direction. The word lines WL0 to WL5 are controlled by the row decoder (31 of FIG. 3), while the bit lines BL0 to BL2 are controlled by the column decoder (36 of FIG. 3). Each memory cell MC includes a sole MOS transistor 2. The source of the MOS transistor 2 is electrically connected to ground via a common source line, not shown. The gate of the MOS transistor 2 is electrically connected to an associated one of the word lines WL0 to WL5, while its drain is electrically connected to an associated one of the bit lines BL0 to BL2 via a variable resistance element 3.

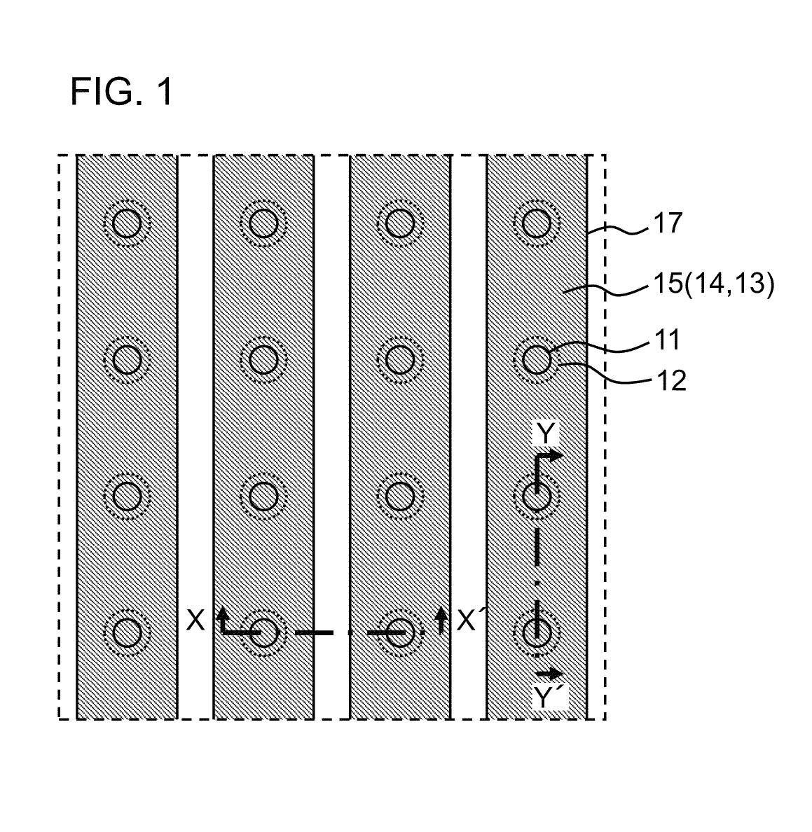

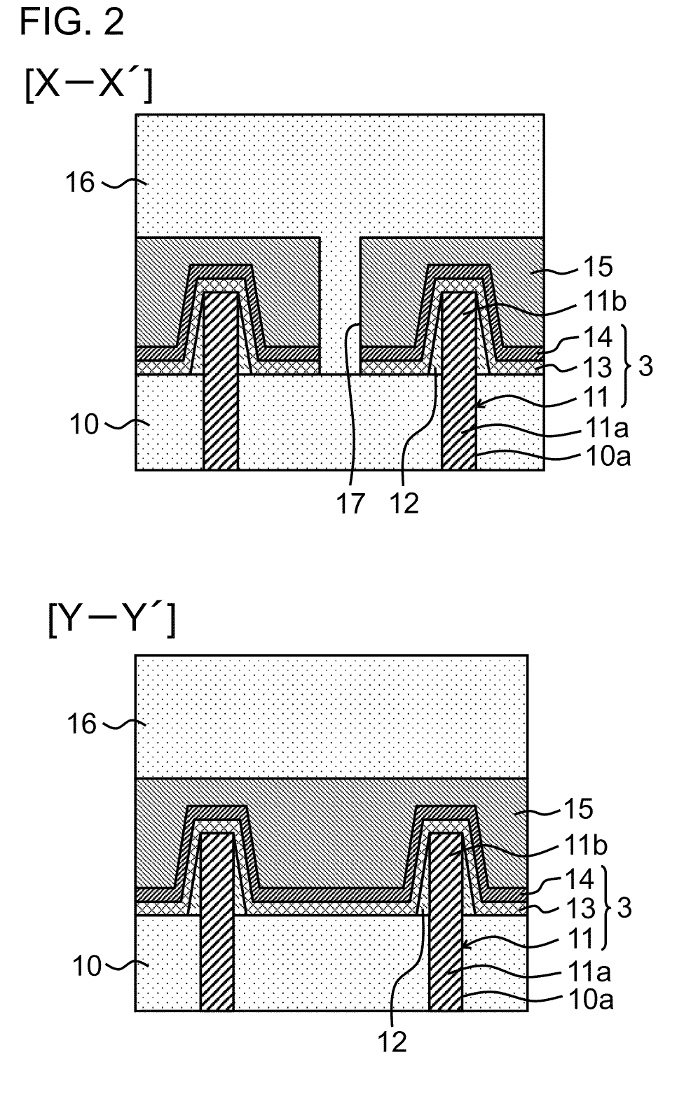

FIG. 1 depicts a plan view schematically showing a configuration of a variable resistance element according to exemplary embodiment 1. FIG. 2 depicts a cross-section along line X-X′ of FIG. 1 and another cross-section along line Y-Y′ of FIG. 1, and schematically shows the configuration of the variable resistance element according to exemplary embodiment 1.

The variable resistance element 3 is such a memory element that is able to change its own resistance value in response to the voltage applied to (or to the current caused to flow through) itself. The variable resistance element 3 has a MIM (Metal-Insulator-Metal) structure according to which a lower electrode 11, a variable resistance film 13 and an upper electrode 14 are layered together. The variable resistance element 3 is a recording element electrically connected to the MOS transistor 2 of FIG. 4) operating as a selection element. The variable resistance element 3 is formed to overlie a layer of the MOS transistor (2 of FIG. 4). An interlayer insulation film 10 is formed on the top of the layer of the MOS transistor (2 of FIG. 4). In the interlayer insulation film 10, such as a silicon oxide film, there is opened a contact hole 10a communicating to a diffusion region, not shown, which is to form a source of the MOS transistor (2 of FIG. 4). It is noted that, should there be another interlayer insulation film as a layer subjacent to the interlayer insulation film 10, the contact hole 10a is opened so as to pass through such other interlayer insulation film as well. In this contact hole, there is embedded a first portion 11a of the lower electrode 11 of, for example, TiN, configured for operating as a contact plug electrically connected to the diffusion region, not shown. The lower electrode 11 includes a columnar-shaped second portion 11b protruded upwards from the first portion 19a. The second portion 11b is protruded (or extended) further upwards from the upper surface of the interlayer insulation film 10. The sidewall surface of the second portion 11b of the lower electrode 11 is covered with a sidewall insulation film 12 of, for example, silicon nitride. Note that the upper surface of the second portion 11b of the lower electrode 11 is not covered with the sidewall insulation film 12.

At a preset position (or region) on the top of the interlayer insulation film 10, including the second portion 11b of the lower electrode 11 and the sidewall insulation film 12 the variable resistance film 13, upper electrode 14 (of, for example, Ta), and an interconnect layer 15 (of, for example tungsten or copper) are stacked in this order, looking from a lower side. The variable resistance film 13, composed of a lower layer of AlOₓ and an upper layer of HfOₓ, as an example, is electrically connected to an upper surface of the second portion 11b of the lower electrode 11. The lower electrode 11, the variable resistance film 13 and the upper electrode 14 together make up the variable resistance element 3. The interconnect layer 15 is to form the bit line (BL of FIG. 3 and BL0 to BL2 of FIG. 4) and is electrically connected to the column decoder (36 of FIG. 3). Like the interconnect layer 15, which is to form the bit line, the variable resistance film 13 and the upper electrode 14 are formed as a line. An end face 17 of a layered assembly, made up of the variable resistance film 13, upper electrode 14 and the interconnect layer 15, is horizontally spaced apart from the sidewall surface of the lower electrode 11, and is arranged overlying the interlayer insulation film 10. A cover insulation film 16 of, for example, silicon oxide, is formed on top of the interlayer insulation film 10 and the layered assembly composed of the variable resistance film 13, upper electrode 14 and the interconnect layer 15.

Turning to the variable resistance element 3, since the variable resistance film 13, formed of a metal oxide, is provided on top of the lower electrode 11, the lower electrode 11 may be formed of an oxidation-resistant electrode material, such as electrically conductive TiN preferentially used in the fabrication of semiconductor devices. The lower electrode 11 is substantially cylindrical-columnar-shaped and made up of the first portion 11a embedded in the contact hole 10a of the interlayer insulation film 10 and the second portion 11b protruded from the first portion 11a upwards beyond the upper surface of the interlayer insulation film 10. The height of the second portion 11b of the lower electrode 11, that is, the length of the second portion 11b from the upper surface of the interlayer insulation film 10 to the upper surface of the second portion 11b, is greater than the diameter of the lower electrode 11. Preferably, the shortest path length from the site of electrical connection between the second portion 11b of the lower electrode 11 and the variable resistance film 13 to the end face 17 of the variable resistance film 13 is not smaller than 50 nm.

The variable resistance film 13 is arranged between the lower electrode 11 and the upper electrode 14. The variable resistance film 13 is electrically connected to both the upper surface of the lower electrode 11 and the lower surface of the upper electrode 14. It is noted that an interjacent layer, such as an oxygen barrier layer, not shown, may be present between the variable resistance film 13 and the upper surface of the lower electrode 11. A low resistance layer, not shown, having the resistance value lower than that of the variable resistance film 13, may be provided between the variable resistance film 13 and the lower surface of the upper electrode 14. The sidewall insulation film 12 is provided between the variable resistance film 13 and the sidewall surface of the second portion 11b of the lower electrode 11. The variable resistance film 13, formed of an oxygen- and metal-containing material, may be formed of a metal oxide, such as HfO₂, Ta₂O₅ or Al₂O₃, or a layered structure thereof. The film thickness of the variable resistance film 13 is not smaller than 1 nm and not greater than 10 nm and preferably not smaller than 2 nm and not greater than 3 nm. If the film thickness exceeds 10 nm, the forming voltage becomes too high. If the film thickness is less than 1 nm, the composition tends to be outside a range of constant resistivity. Note that, in case the variable resistance film 13 is composed of the lower layer of AlOₓ and the upper layer of HfOₓ, the film thickness of each of AlOₓ and HfOₓ may be 0.5 to 5 nm.

The upper electrode 14 may be formed of metals, such as TiN, Ti or Ta, or formed by an upper layer of TiN, an intermediate layer of Ti and a lower layer of Ta, stacked together. The film thickness of the upper electrode 14 may be not smaller than 15 nm and not greater than 25 nm.

Turning to the operation of the variable resistance element 3, if the voltage is applied so that the voltage applied to the lower electrode 11 will be more negative than the upper electrode 14 as reference, the variable resistance element 3 shifts from the high resistance state to the low resistance state (to a set state). If conversely the voltage is applied so that the voltage applied to the lower electrode 11 will be more positive than the upper electrode 14 as reference, the variable resistance element 3 shifts from the low resistance state to the high resistance state (to a set state). It is noted that, since the variable resistance film 13 used in the variable resistance element 3 is an insulation film, insulation destruction by a voltage termed forming (forming voltage) is initially carried out in the variable resistance element 3.

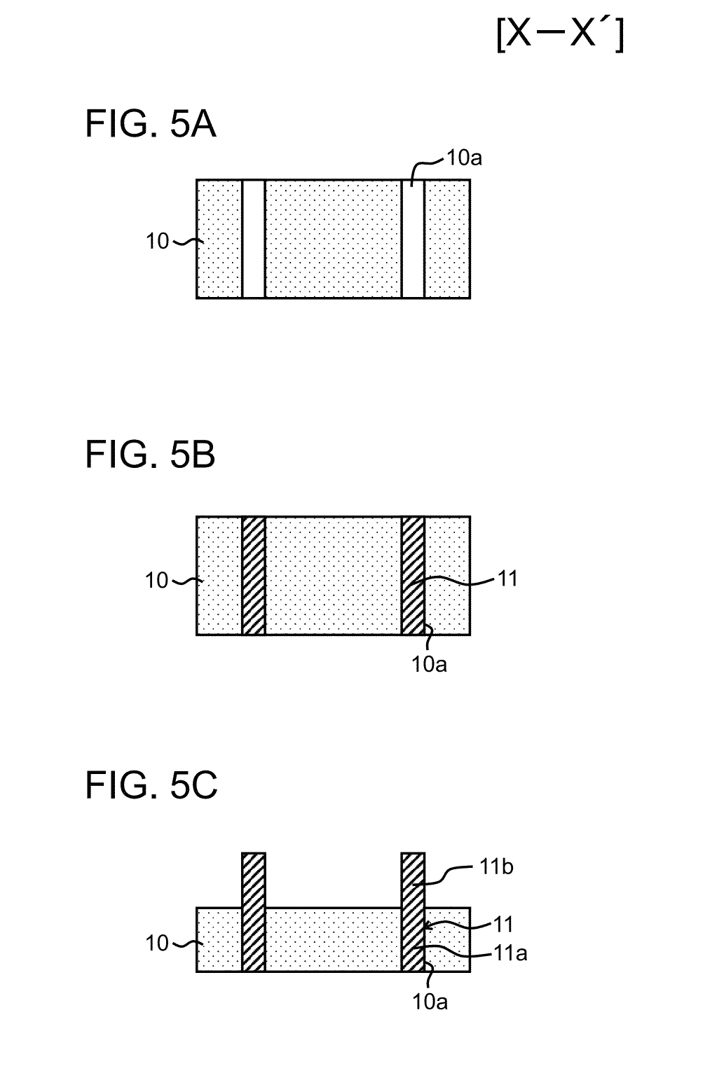

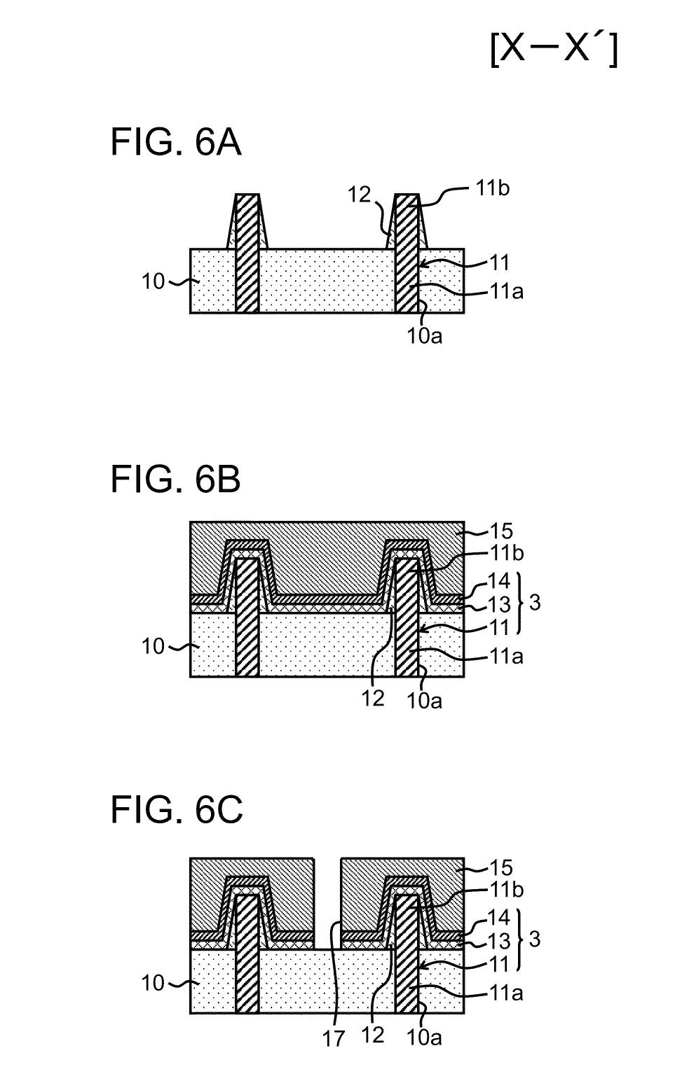

The manufacturing method of the variable resistance element according to the subject exemplary embodiment 1 will now be described with reference to the drawings. FIGS. 5A to 5C depict cross-sectional views, taken along lines X-X′ of FIG. 1, schematically showing respective process steps of the manufacturing method for the variable resistance element according to exemplary embodiment 1. FIGS. 6A to 6C are cross-sectional views schematically showing respective process steps, consecutive to those of FIGS. 5A, 5B and 5C, for manufacturing the variable resistance element according to exemplary embodiment 1.

Initially, the interlayer insulation film 10 is deposited on the top of the layer of the MOS transistor (2 of FIG. 4), here not shown. Then, using the lithographic and etching techniques, the contact hole 10a is opened through the interlayer insulation film 10 in a step A1, see FIG. 5A. This contact hole is to communicate with a diffusion layer, not shown, which will form a source of the MOS transistor (2 of FIG. 4). It is noted that, should there be another interlayer insulation film subjacent to the interlayer insulation film 10, the contact hole is opened so that it will pass through such other interlayer insulation film as well.

The lower electrode 11 is then formed within the contact hole 10a in a step A2, see FIG. 5B. In forming the lower electrode 11, a TiN film may be deposited on the top of the interlayer insulation film 10, now including the contact hole 10a, and the so deposited TiN film may be planarized by CMP (Chemical Mechanical Polishing) until the upper surface of the interlayer insulation film 10 is exposed.

The interlayer insulation film 10 is then selectively removed by etchback in a step A3 so as to expose the sidewall surface of the second portion 11b of the lower electrode 11, see FIG. 6A.

The sidewall insulation film 12 is then formed in a step A4 on the sidewall surface of the second portion 11b of the lower electrode 11, see FIG. 6A. In forming the sidewall insulation film 12, a silicon nitride film may be deposited on the second portion 11b of the lower electrode 11 and on the interlayer insulation film 10. The silicon nitride film may then be selectively removed by etchback until the interlayer insulation film 10 and the upper surface of the second portion 11b of the lower electrode 11 are exposed.

The variable resistance film 13, upper electrode 14 and the interconnect layer 15 are then deposited in a step A5 in this order on the top of the interlayer insulation film 10, the second portion 11b of the lower electrode 11 and the sidewall insulation film 12, see FIG. 6B. It is noted that, in forming the variable resistance film 13, hafnium oxide HfOₓ, exhibiting oxygen deficiencies, may be obtained using only an Ar sputtering gas against an HfO₂ target, as an example. The upper electrode 14 may be formed by dc (direct current) sputtering against a Ta target, as an example. In forming the interconnect layer 15, a tungsten film may be formed by CVD (Chemical Vapor Deposition) and then planarized by CMP.

Then, using lithographic and etching techniques, preset sites of the variable resistance film 13, upper electrode 14 and the interconnect layer 15 are removed in a step A6, see FIG. 6C. This will form an end face 17 of the layered assembly of the variable resistance film 13, upper electrode 14 and the interconnect layer 15.

Finally, the cover insulation film 16 is deposited on top of the interlayer insulation film 10, now carrying thereon the variable resistance film 13, upper electrode 14 and the interconnect layer 15, in a step A7, see FIG. 2. In forming the cover insulation film 16, a silicon oxide film may be deposited by CVD and subsequently planarized by CMP.

According to exemplary embodiment 1, it is possible to set the variable resistance portion of the variable resistance element 3 (variable resistance film 13/upper electrode 14/interconnect layer 15) at a sizable distance from the site subject to etching (end face 17). By setting this distance at a larger value, it is possible to reduce etching damages as well as adverse effects the oxidation of the end face 17 of the variable resistance film 13 might have on the switching or the forming of the variable resistance element 3. Attention should be directed to the fact that switching or forming takes place at a site where the variable resistance film 13 has not been subject to damages or end face oxidation.

In addition, according to exemplary embodiment 1, the lower electrode 11 is protruded upwards beyond the upper surface of the interlayer insulation film 10, and the sidewall surface of the second portion 11b of the lower electrode 11 is set apart by the sidewall insulation film 12 from the variable resistance film 13. It is thus possible to prevent a filament from being formed on the second portion 11b as well as to force the filament to be formed on the upper surface of the second portion 11b. Since the filament is formed on the upper surface of the second portion 11b of the lower electrode 11 of each of a plurality of the variable resistance elements 3, it is possible to suppress fluctuations in the characteristic from one variable resistance element 3 to another.

### Exemplary Embodiment 2

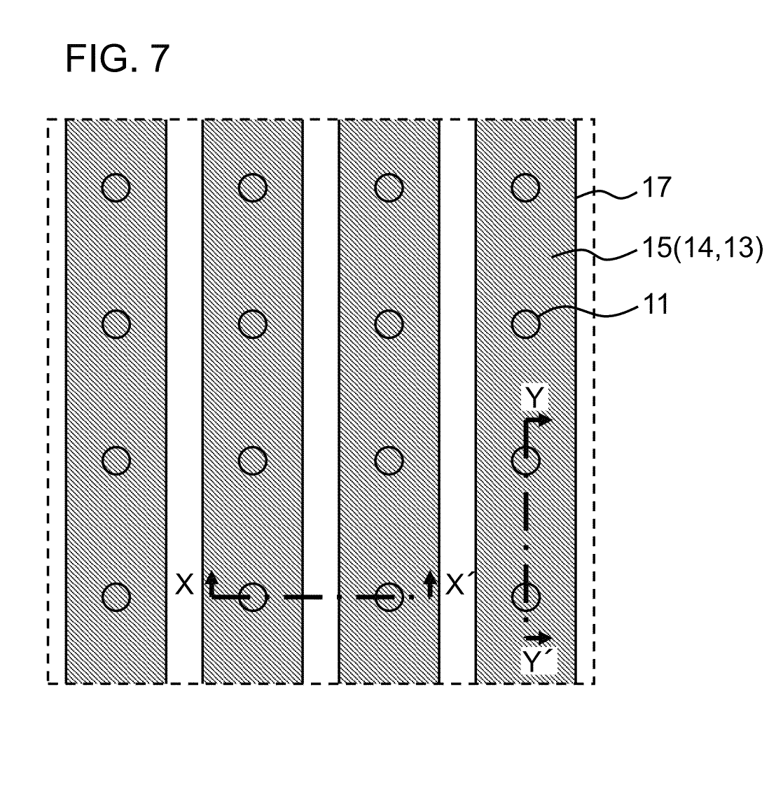

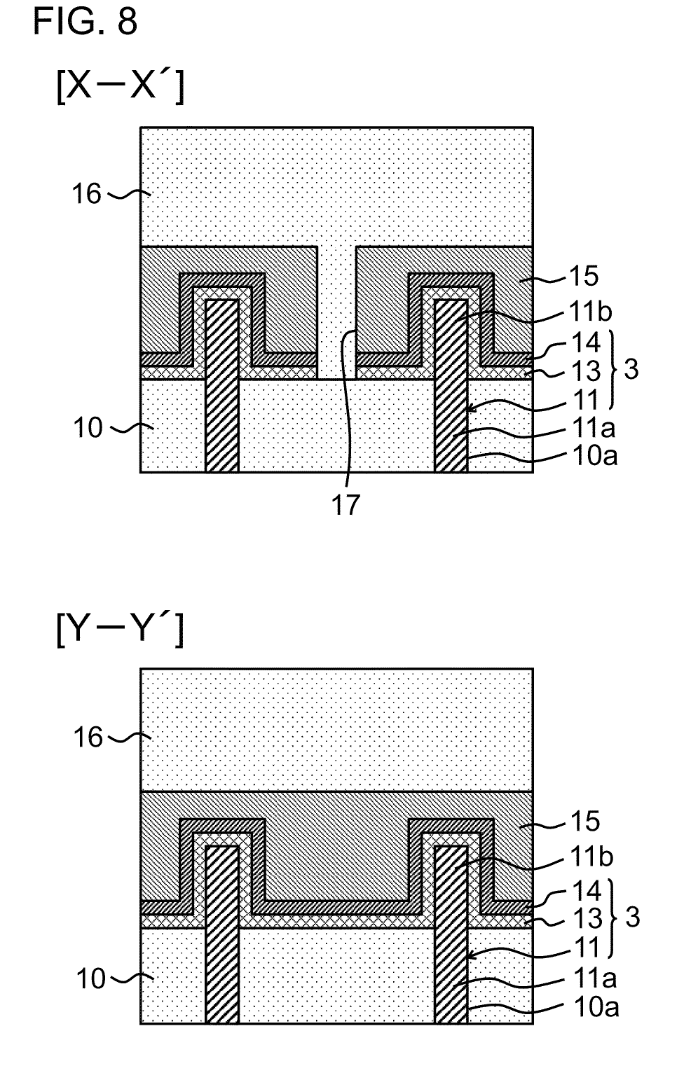

A variable resistance element according to exemplary embodiment 2 will now be explained with reference to the drawings. FIG. 7 depicts a plan view schematically showing a configuration of a variable resistance element of exemplary embodiment 2. FIG. 8 depicts a cross-section along line X-X′ and a cross-section along line Y-Y′ of FIG. 7, and schematically shows the configuration of the variable resistance element of exemplary embodiment 2.

The exemplary embodiment 2 is a modification of exemplary embodiment 1 in which the sidewall insulation film (12 of FIG. 4) in the configuration of exemplary embodiment 1 is dispensed with and in which the variable resistance film 13 is attached not only to the upper surface of the second portion 11b of the lower electrode 11 but also to its sidewall surface. In short, the variable resistance film 13 and the upper electrode 14 are attached to the sidewall surface of the second portion 11b of the lower electrode 11 as well so that the sidewall surface of the second portion 11b of the lower electrode 11 is also of the MIM structure. Hence, the sidewall surface of the second portion 11b of the lower electrode 11 may be exploited as the lower electrode of the variable resistance element 3. The portions of the variable resistance film 13 and the upper electrode 14 on the second portion 11b of the lower electrode 11 are kept and a distance is set between the resistance variable portion of the variable resistance element 3 and the patterned portion (end face 17). Like the interconnect layer 15, which will be used as a bit line (equivalent to BL of FIG. 3 and BL0 to BL2 in FIG. 4), the variable resistance film 13 and the upper electrode 14 are formed as a line. Otherwise, the configuration as well as the operation of the subject exemplary embodiment is similar to those of exemplary embodiment 1.

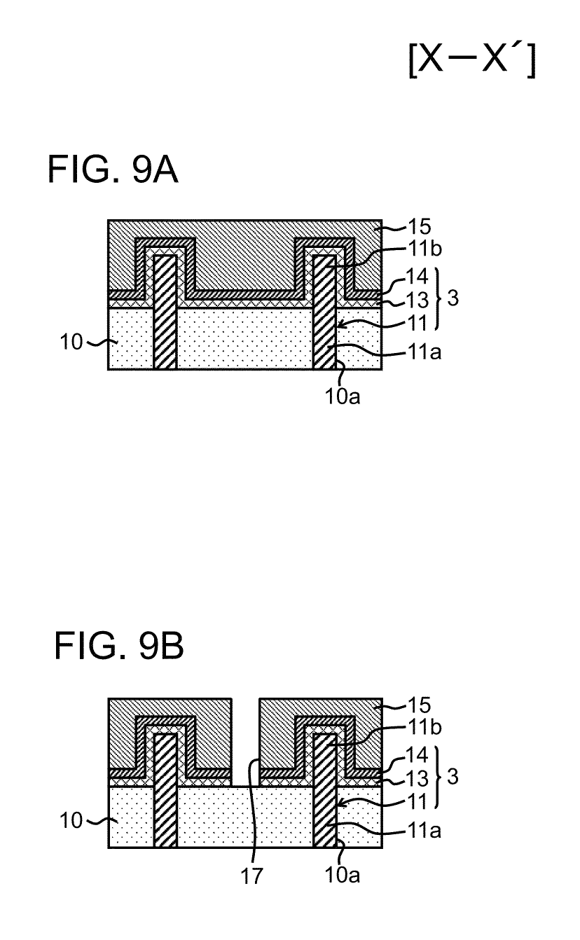

The manufacturing method of the variable resistance element according to the subject exemplary embodiment 2 will now be described with reference to the drawings. FIGS. 9A, 9B are cross-sectional views, taken along lines X-X′ of FIG. 7, schematically showing respective process steps of the manufacturing method for the variable resistance element according to exemplary embodiment 2.

Initially, using process steps similar to the process steps A1 to A3 of exemplary embodiment 1, such assembly in which the first portion 11a of the lower electrode 11 is buried in the contact hole 10a of the interlayer insulation film 10 and the second portion 11b of the lower electrode 11 is protruded upwards beyond the upper surface of the interlayer insulation film 10, is prepared in a step B1, as shown in FIG. 5C. In the step B1, the portion of the interlayer insulation film 10 around the second portion 11b of the lower electrode 11 is again etched back to expose the sidewall surface of the second portion 11b of the lower electrode 11.

Then, on the interlayer insulation film 10 and on the second portion 11b of the lower electrode 11, the variable resistance film 13, upper electrode 14 and the interconnect layer 15 are deposited in a step B2 in this order, see FIG. 9A.

Then, using the lithographic and etching techniques, preset sites of the variable resistance film 13, upper electrode 14 and the interconnect layer 15 are removed in a step B3, see FIG. 9B. This will form an end face 17 of a layered assembly of the variable resistance film 13, upper electrode 14 and the interconnect layer 15.

Finally, a cover insulation film 16 is deposited on the interlayer insulation film 10, the variable resistance film 13, the upper electrode 14 and on the interconnect layer 15, in a step B4, see FIG. 8A and FIG. 8B.

The above describes the variable resistance element according to exemplary embodiment 2. In deriving the variable resistance element according to exemplary embodiment 2, the present inventors have conducted various experiments, as now explained, and have arrived at the following information:

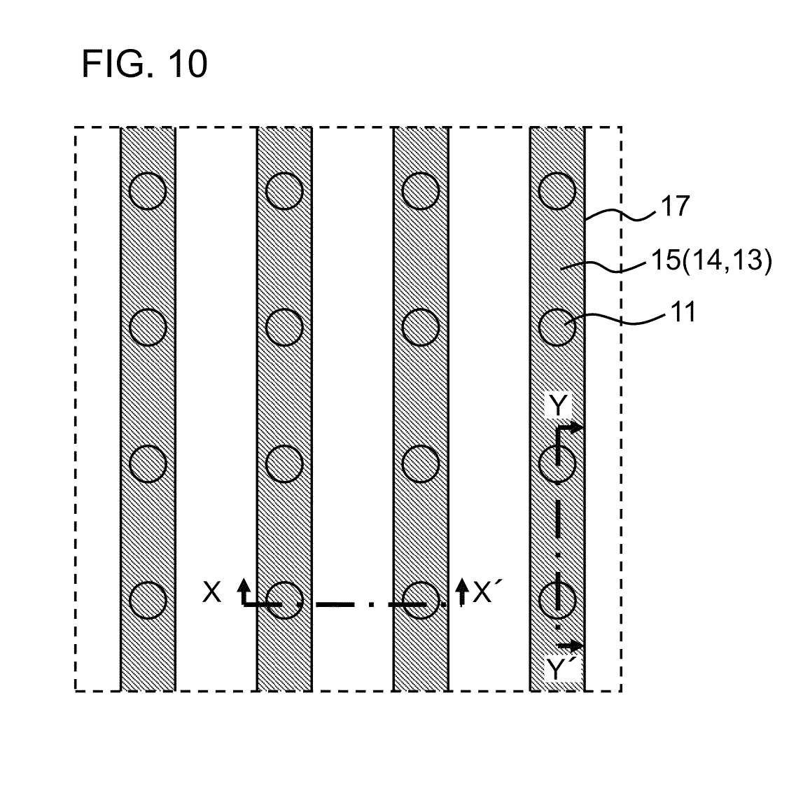

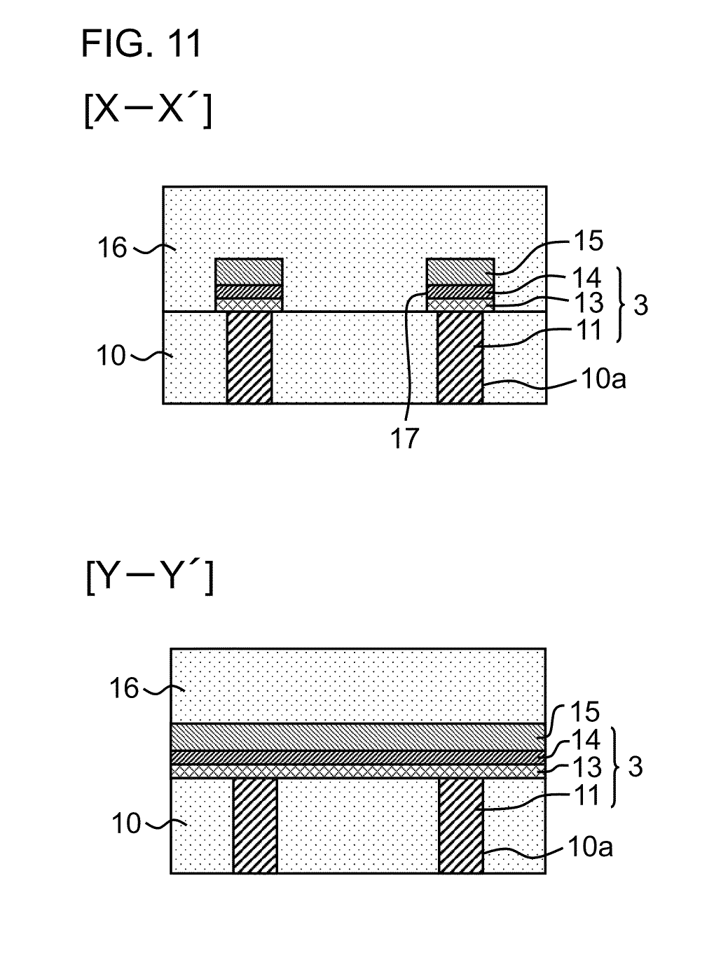

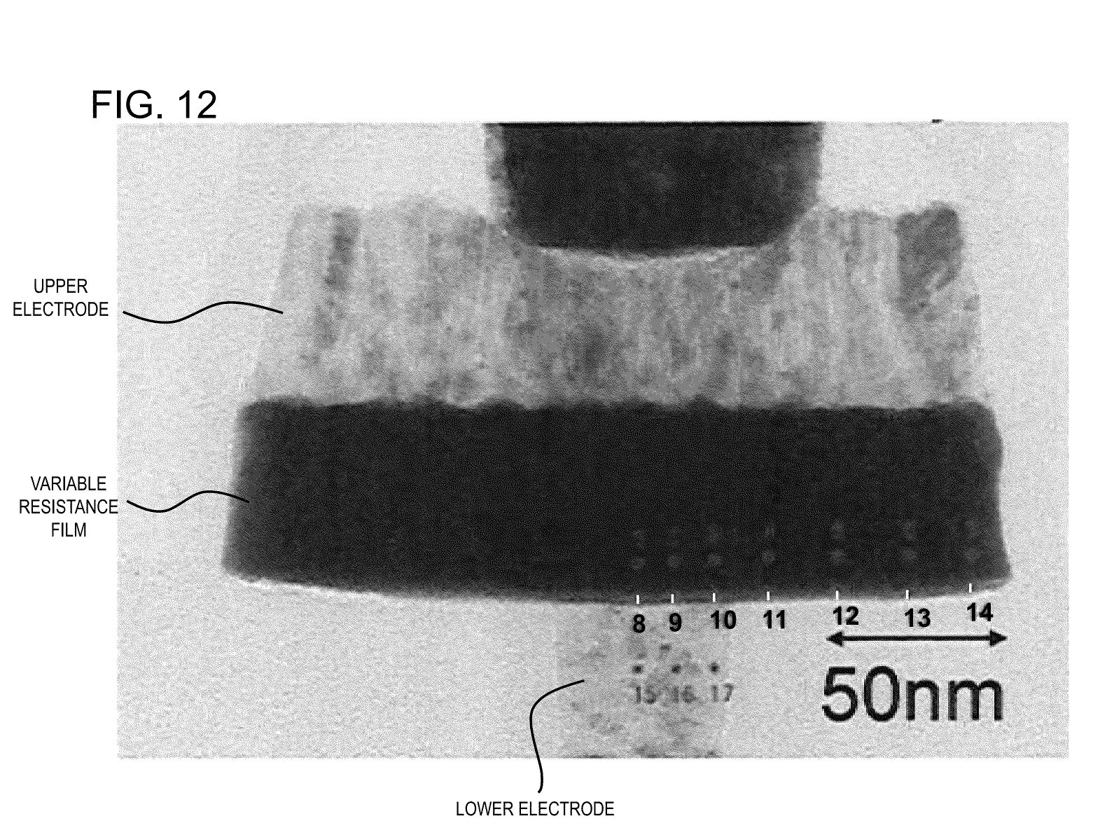

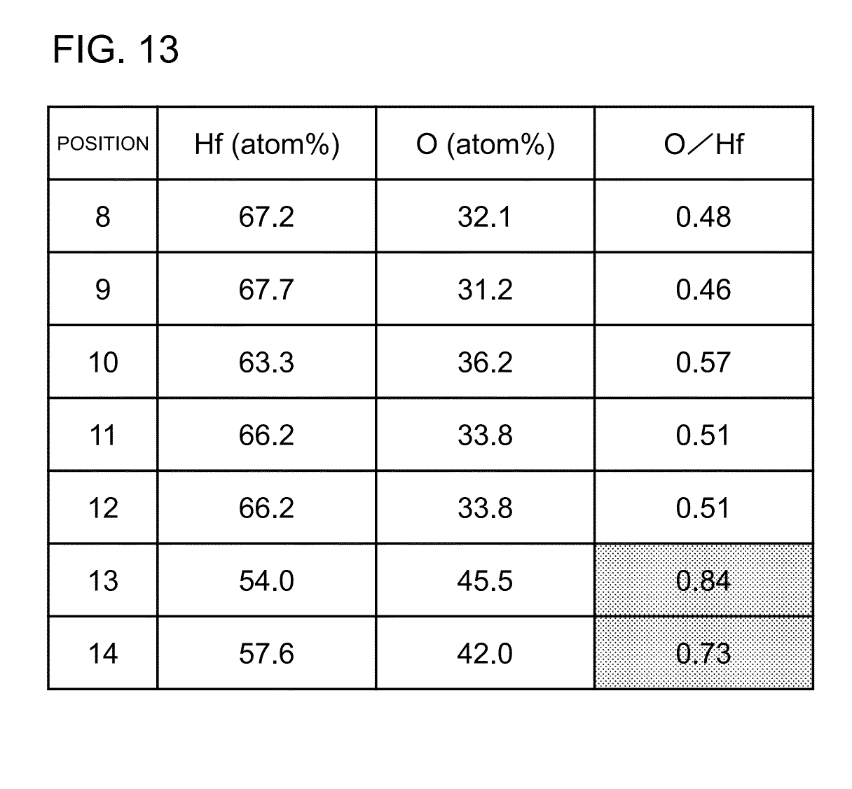

Initially, deterioration in the vicinity of an end face of a variable resistance film of a variable resistance element will be explained using a comparative example. FIG. 10 depicts a plan view schematically showing the configuration of a variable resistance element according to the comparative example. FIG. 11 depicts a cross-section along line X-X′ and a cross-section along line Y-Y′ of FIG. 10, and schematically shows the configuration of the variable resistance element according to the comparative example. FIG. 12 shows an image of a variable resistance element tentatively manufactured by TEG. FIG. 13 depicts a tabulated view showing the atomic composition (%) of Hf and O as measured at points 8 to 14 of the variable resistance element of comparative example in FIG. 12 by EDX as well as the content ratio (O/Hf).

In a variable resistance element 3 according to the comparative example, the lower electrode 11 is not protruded upwards beyond the upper surface of the interlayer insulation film 10, and the upper surface of the lower electrode 11 is attached to the variable resistance film 13, see FIG. 10 and FIG. 11. The variable resistance film 13 and the upper electrode 14 of the variable resistance element 3 of the comparative example are planar. Otherwise, the comparative example is similar in configuration to exemplary embodiment 2.

To search into deterioration in the vicinity of the end face (surface etched) of the variable resistance film of the variable resistance element, a variable resistance element of the comparative example was tentatively fabricated by TEG (Test Element Group). The variable resistance element is shown as a TEM (Transmission Electron Microscope) image in FIG. 12. Measurements were then made by EDX (Energy Dispersive X-ray Spectrometer) of the atomic composition (%) as well as the content ratio of a metal component (Hf) and an oxygen component (0) at respective positions (positions 8 to 14) from the end face of the variable resistance film (HfOₓ), see FIG. 13. It is noted that, in FIG. 12, the lower electrode is formed of TiN which is 65 nm in diameter, the variable resistance film being formed of AlOₓ/HfOₓ, with the total film thickness being 4.5 nm and respective film thicknesses being 1.5 nm/3 nm. The upper electrode is formed of TiN/Ti/Ta, with the total film thickness being 105 nm and respective film thicknesses being 50/5/50 nm.

An analysis of the O content in the variable resistance film (HfOₓ) at each of the positions 8 to 12 of FIG. 12 from the end face of the variable resistance film has revealed that the O ratio is high at positions up to ca. 30 nm from the end face of the variable resistance film, specifically at the positions 13, 14 of FIG. 12. See shaded potions in FIG. 13. Inwardly of the position in the vicinity of 50 nm from the end face of the variable resistance film, that is, from the position 8 up to the position 12 in FIG. 12, the ratio of O coincides with the ratio of the original variable resistance film. In short, the end face portion of the variable resistance film is oxidized, that is, end-face oxidized, at the time of patterning the variable resistance film by etching and film forming of the cover insulation film. In other words, the effect of end-face oxidization ceases at a position about 50 nm inwards from the end face of the variable resistance film and at further inward positions.

It is seen from above that, in the variable resistance element of exemplary embodiment 2 (3 of FIG. 8), if etchback of the interlayer insulation film 10 is done at about 50 nm from the vicinity of the second portion (11b of FIG. 8) of the lower electrode (11 of FIG. 8), it is possible to prevent the effect of end-face oxidation or etching damages of the portion of the variable resistance film (13 of FIG. 8) attached to the second portion (11b of FIG. 8) of the variable resistance film (13 of FIG. 8). In the variable resistance element (3 of FIG. 8) according to exemplary embodiment 2, the length of the variable resistance film (13 of FIG. 8) affected from the end face is extremely small despite miniaturization. Since the length of the variable resistance film (13 of FIG. 8) along the height of the second portion (11b of FIG. 8) of the variable resistance element (3 of FIG. 8) remains constant, the structure described above is not affected by the process or miniaturization, thus assuring the operation of the variable resistance element (3 of FIG. 8).

With the variable resistance element of the generation with less than 40 nm line width, it is becoming extremely difficult to prepare the element to the BEOL (Back End of Line) in the interconnect process as the bit line configuration is maintained. In the generation with less than 40 nm line width, the bit line is patterned to the line width of 38 nm. Hence, the lower electrode/variable resistance film/upper electrode section, which takes charge of switching, tends to be affected by a damaged layer produced by etching, that is, the damaged layer of the variable resistance element.

Also, if the variable resistance film is of the dual layer structure of a switching layer (AlOₓ)/reservoir layer (HfOₓ), a native oxide layer is formed on the sidewall surface of the metal-rich reservoir layer (HfOₓ) before forming the cover insulation layer. Hence, the oxygen profile of the switching layer (AlOₓ) and the reservoir layer (HfOₓ) is changed under the heat of BEOL to render difficult the destruction of insulation (forming) which is to be carried out using a voltage (forming voltage) before the operation of the variable resistance element. If damages of the end face of the variable resistance film or its vicinity or oxygen intrusion raise the value of the voltage necessary for forming, such that the forming voltage exceeds the drain withstand voltage of the MOS transistor as the selection element, the operation as the variable resistance element may be incapacitated. These factors are difficult to cope with solely by process improvement or by management of the ‘process retention’ time, and hence are deterrent to achieving satisfactory operations of the variable resistance element of the generation with less than 40 nm line width.

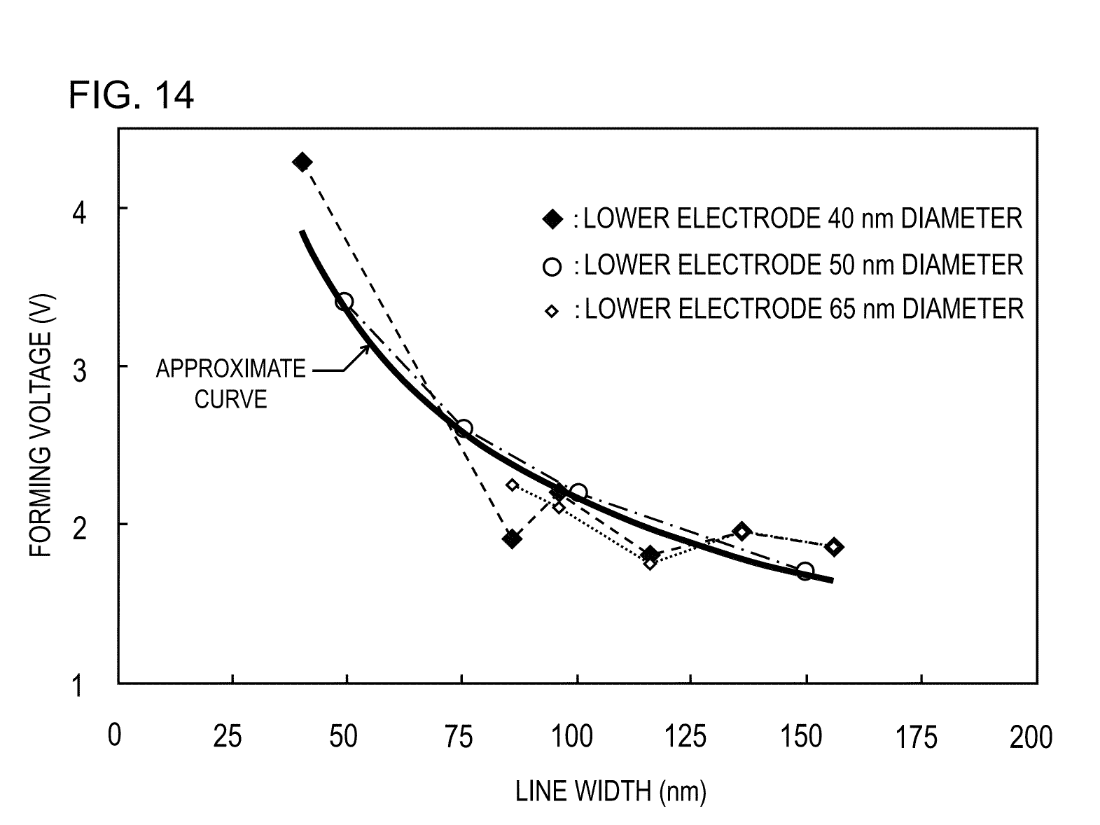

The relationship among the diameter of the lower electrode, line widths of the variable resistance film as well as upper electrode, and the forming voltage, in the variable resistance element, will now be scrutinized using the comparative example. FIG. 14 depicts a graph showing the relationship among the diameters of the lower electrodes, line widths (line widths of the variable resistance films and the upper electrodes) and the forming voltage in the variable resistance elements of the comparative example.

In the variable resistance element according to the comparative example (FIG. 11), it is only at the upper surface of the lower electrode (11 of FIG. 11) that the lower electrode is contacted with the variable resistance film (13 of FIG. 11). The area operating as a variable resistance region becomes smaller as the design rule becomes more minuscule. The forming voltage Vf increases as the design rule becomes more minuscule. Thus, to search into the relationship among the diameters of the lower electrodes, line widths of the upper electrodes and the variable resistance films and the forming voltage in the variable resistance element, a number of prototype variable resistance elements of the comparative example were tentatively fabricated and the forming voltage Vf was checked. These prototype variable resistance elements were those having the lower electrode 65 nm in diameter, the lower electrode 50 nm in diameter and the lower electrode 40 nm in diameter, each of which was associated with several different values of the line widths of the variable resistance films and the upper electrodes, see FIG. 14. It is observed that the lower electrode used was formed of TiN, the variable resistance film used was of AlOₓ/HfOₓ (total film thickness of 4.5 nm, with the individual film thicknesses being 1.5 nm/3 nm), and the upper electrode used was TiN/Ti/Ta (total film thickness being 105 nm, with the film thicknesses of TiN/Ti/Ta being 50/5/50 nm).

Measurements were made of the forming voltages Vf for the different values of line widths of the variable resistance films and the upper electrodes. It was now found that, as shown in FIG. 14, with the variable resistance elements with the lower electrodes 65 nm in diameter, the forming voltage Vf was raised gradually as the line widths (line widths of the variable resistance films and the upper electrodes) were reduced. With the variable resistance elements with the lower electrodes 50 nm in diameter, the forming voltage Vf increased more acutely than with the variable resistance elements with the lower electrode 65 nm in diameter as the line widths (line widths of the variable resistance films and the upper electrodes) were reduced. With the variable resistance element with the lower electrode 40 nm in diameter, the forming voltage Vf increased more acutely than with the variable resistance elements with the lower electrodes 50 nm in diameter as the line widths (line widths of the variable resistance films and the upper electrodes) were reduced.

From the results of FIG. 14, it is seen that the longer the line width of the variable resistance film, the lesser may be the forming voltage that is to be used. This may be due to the fact that, since the line width of the variable resistance film is increased, the site of the filament formed is separated farther away from the end face (etched surface) of the variable resistance film, so that the oxygen deficiencies concentration may be stabilized by circumventing the damage ascribable to oxygen intrusion. If conversely the variable resistance film has a shorter line width, oxygen intrusion to the site of the filament formed may possibly be produced to lower the concentration of oxygen deficiencies to increase the forming voltage. Such increased forming voltage is not desirable because a MOS transistor with a larger withstand voltage would then be required to control it, while the current path generated within each variable resistance film at the time of the forming would be fluctuated more severely. If the line width of the variable resistance film is increased solely in the planar direction, it is possible to circumvent the damage ascribable to the oxygen intrusion. This, however, does not lend itself to miniaturization because the chip area would then be increased. For this reason, in the variable resistance element (3 of FIG. 8) according to exemplary embodiment 2, the second portion (11b of FIG. 8) of the lower electrode (11 of FIG. 8) protruded upwards beyond the upper surface of the interlayer insulation film (10 of FIG. 8) is coated with the variable resistance film (13 of FIG. 8) so as to comminute the size and so as to reduce the forming voltage.

It is observed that increase in the forming voltage Vf caused by reduction in line widths (line widths of the variable resistance film and the upper electrode) is ascribable to increase in oxygen deficiencies. If the line widths (line width of the variable resistance film and that of the upper electrode) are greater, many oxygen deficiencies are retained in the variable resistance element. If, in this case, a constant electrical field is applied, the site where oxygen deficiencies are incidentally concentrated is susceptible to forming.

However, if the line widths (line width of the variable resistance film and that of the upper electrode) are reduced, oxygen deficiencies retained in the element are decreased, so that, when a preset electrical field is applied, the probability of forming decreases. For compensation, it becomes necessary to apply a larger forming voltage Vf. Since it is necessary for the forming voltage Vf to be smaller than the drain withstand voltage of the MOS transistor operating as a selection element, such increase in the forming voltage Vf may be said to be deterrent to miniaturizing the variable resistance element.

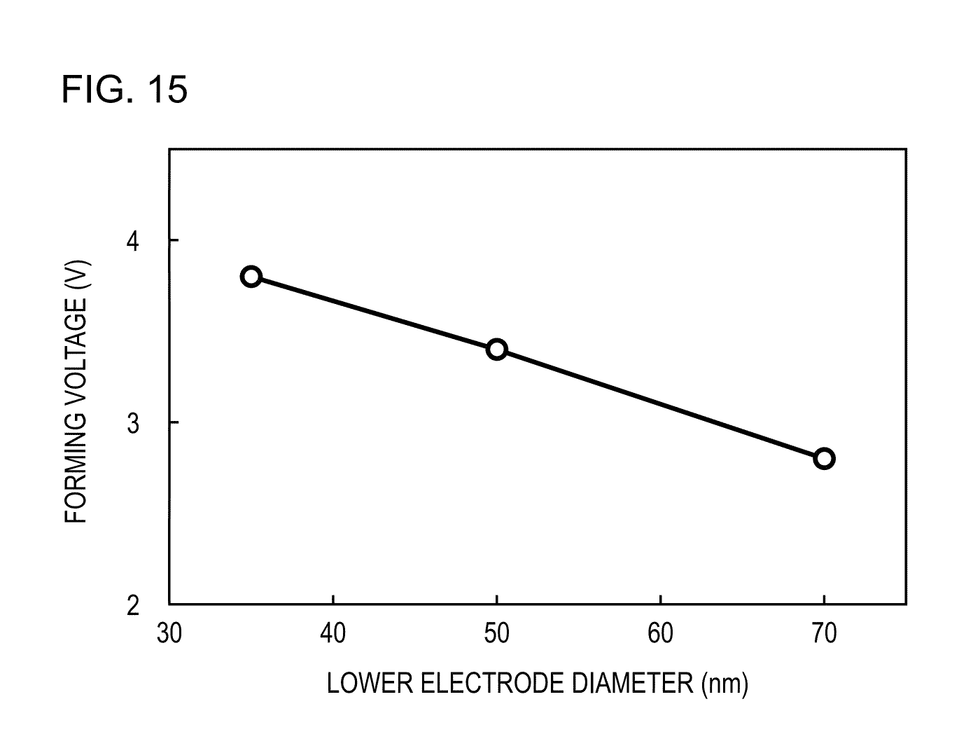

The relationship between the forming voltage and the diameter of the lower electrode in the variable resistance element will now be checked using the comparative example. FIG. 15 shows the relationship between the diameters of the lower electrodes of the variable resistance elements of the comparative example and the forming voltage.

To search into the relationship between the forming voltage and the diameter of the lower electrode in the variable resistance element, a number of prototype variable resistance elements of the comparative example were tentatively fabricated to check the forming voltages Vf, see FIG. 15. These prototype variable resistance elements were those having a plurality of different diameters of the lower electrodes with the line widths of the variable resistance films and the upper electrodes being 150 nm. It is observed that the lower electrode used was formed of TiN, the variable resistance film used was of AlOₓ/HfOₓ (total film thickness being 4.5 nm, with the individual film thicknesses being 1.5 nm/3 nm), and the upper electrode used was TiN/Ti/Ta (total film thickness being 105 nm, with the film thicknesses of TiN/Ti/Ta being 50/5/50 nm).

Measurements were made of the forming voltage Vf for the different diameters of the lower electrodes in the prototype variable resistance elements. It was thus found that the forming voltage may be reduced by increasing the diameter of the lower electrode, as shown in FIG. 15. The reason may be such that the larger the diameter, the higher is the expectation of covering a path where the filament can be formed, regardless of the concentration of oxygen deficiencies. In the variable resistance element (3 of FIG. 8) according to exemplary embodiment 2, the filament can be formed not only on the upper surface of the second portion (11b of FIG. 8) of the lower electrode (11 of FIG. 8), but also on its sidewall surface. Hence, the forming voltage may be expected to be further reduced in comparison to exemplary embodiment 1. In particular, the structure described is most beneficent for the above mentioned case with only small characteristic fluctuations.

The relationship between the film thickness of the variable resistance film in the variable resistance element and the forming voltage will now be scrutinized using the comparative example.

To search into the relationship between the forming voltage and the film thickness of the variable resistance film in the variable resistance element, a number of prototype variable resistance elements of the comparative example were tentatively fabricated and the forming voltage was checked. These prototype variable resistance elements were those having a plurality of different film thicknesses with the line widths of the variable resistance films and the upper electrodes being 150 nm. It is observed that the lower electrode used was formed of TiN, with the diameter of 50 nm, the variable resistance film used was of AlOₓ/HfOₓ, and the upper electrode used was TiN/Ti/Ta (total film thickness being 105 nm, with TiN/Ti/Ta film thicknesses being 50/5/50 nm).

Measurements were made of the forming voltages for different film thicknesses of the variable resistance films in the prototype variable resistance elements. It was thus found that, with the AlOₓ film thickness 1 nm and HfOₓ film thickness of 5 nm, the forming voltage was 2.3V, with the AlOₓ film thickness 1 nm and HfOₓ film thickness of 7 nm, the forming voltage was 2.3V and, with the AlOₓ film thickness 1 nm and HfOₓ film thickness of 9 nm, the forming voltage was 2.2V. It was thus found that the desired forming voltage may be obtained even with the total film thickness of the variable resistance film of 10 nm. As for the AlOₓ film thickness, it is desirably not less than 0.5 nm and not greater than 2 nm. However, it may exceed 2 nm subject to changes made in the HfOₓ composition.

According to exemplary embodiment 2, the MIM structure is used even for the sidewall surface of the second portion 11b of the lower electrode 11 to secure an area functioning as a variable resistance region. Moreover, in exemplary embodiment 2, since the oxygen deficiencies retained in the variable resistance element 3 are not decreased, the forming voltage is not increased. Additionally, in exemplary embodiment 2, the sidewall surface of the second portion 11b of the lower electrode 11 may be exploited as the variable resistance region by adjusting the depth of etchback of the interlayer insulation film. Furthermore, with exemplary embodiment 2, the area functioning as the variable resistance region may be adjusted with ease by adjusting the depth of etchback of the interlayer insulation film 10. Hence, the area functioning as the variable resistance region may be maintained constant, with the result that a constant characteristic may be maintained regardless of the generations, with the characteristic of the variable resistance element 3 not being affected by the difference in the process, material type or design rule comminution.

### Exemplary Embodiment 3

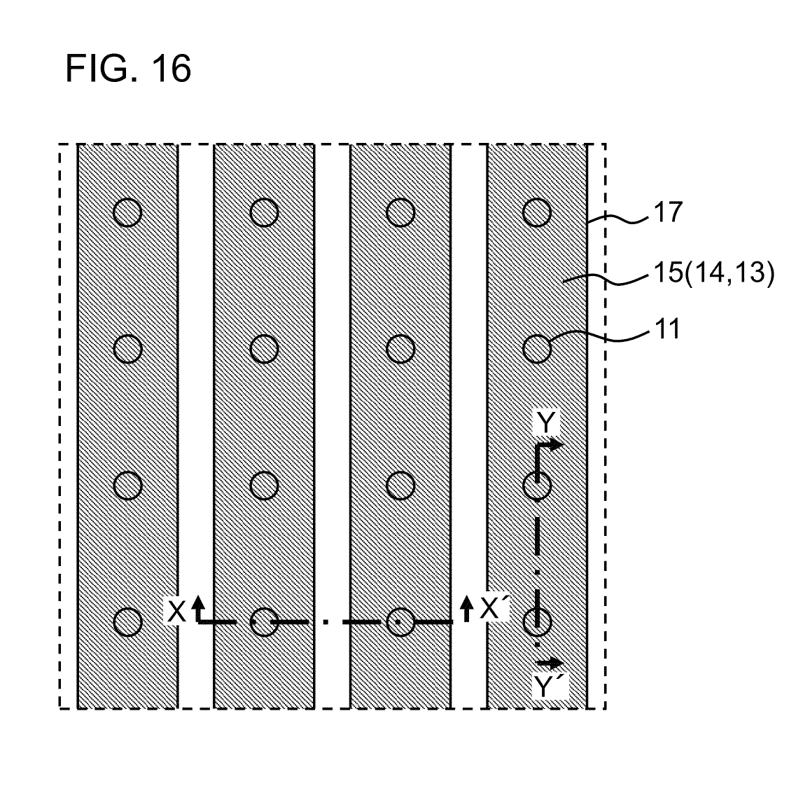

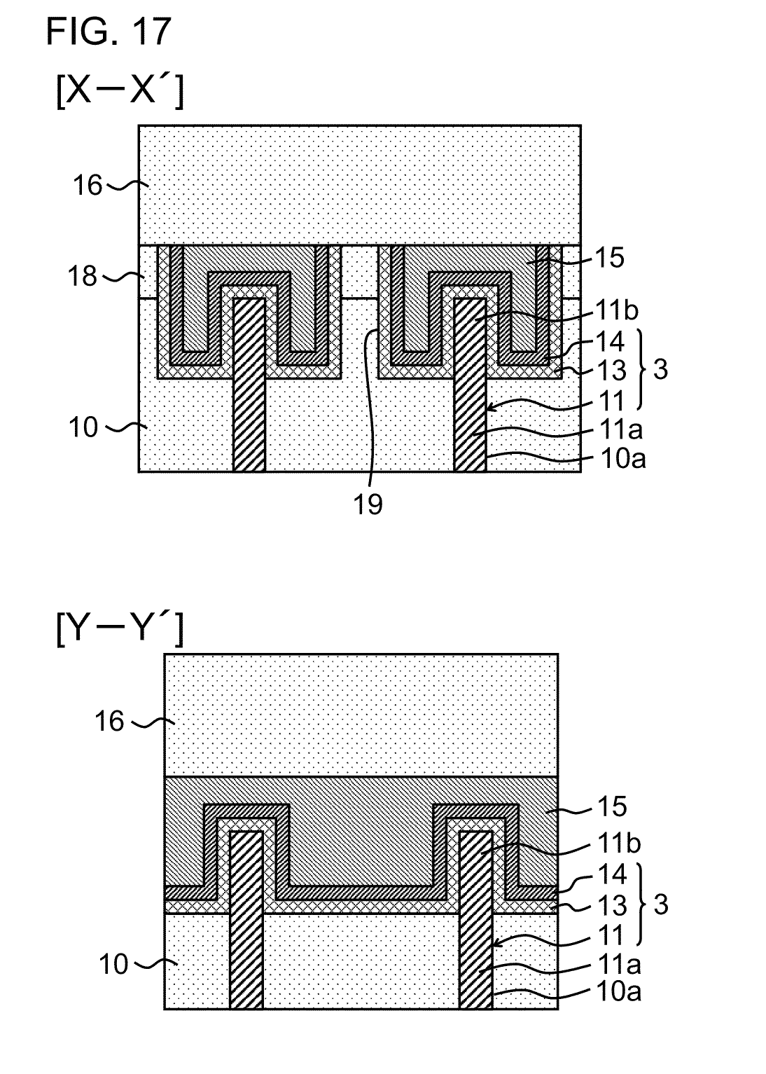

A variable resistance element according to exemplary embodiment 3 will now be explained with reference to the drawings. FIG. 16 depicts a plan view schematically showing a configuration of exemplary embodiment 3. FIG. 17 depicts a cross-section along line X-X′, and a cross-section along line Y-Y′, of FIG. 16, and schematically shows the configuration of exemplary embodiment 3.

The exemplary embodiment 3 is a modification of exemplary embodiment 2. In this modification, the variable resistance film 13, upper electrode 14 and the interconnect layer 15 are of the fill interconnection structure that uses the damascene method. In exemplary embodiment 3, as in exemplary embodiment 2, the variable resistance film 13 and the upper electrode 14 are formed on the sidewall surface of the second portion 11b of the lower electrode 11 as well so that the MIM structure is maintained even on the sidewall surface of the second portion 11b of the lower electrode 11.

On top of the layer of the MOS transistor (2 of FIG. 4), there are formed interlayer insulation films 10, 18, formed of silicon oxide, as an example. In the interlayer insulation films 10, 18, there is formed a trench 19 that is to form a bottom surface at a middle part of the interlayer insulation film 10. The trench 19 is formed extending along the interconnect layer 15 operating as a bit line. A contact hole 10a, beginning at a preset site of the bottom of the trench 19 and communicating to a diffusion layer, not shown, which is to form a source of the MOS transistor (2 of FIG. 4), is opened in the interlayer insulation film 10 formed of, for example silicon oxide. It is noted that, if there is provided another interlayer insulation film subjacent to the interlayer insulation film 10, the contact hole is to pass through this other interlayer insulation film as well. A first portion 11a of a lower electrode 11, formed of, for example TiN, and which is to be a contact plug electrically connected to the diffusion layer, not shown, fills the contact hole 10a. The lower electrode 11 includes, within the trench 19, a second portion 11b projected or extended upwards from the first portion 11a. The second portion 11b is projected or extended upwards beyond the bottom surface of the trench 19. The upper surface of the second portion 11b is flush with the upper surface of the interlayer insulation film 10.

Within the trench 19, in which is disposed the lower electrode 11 (second portion 11b), there are arranged, looking from a lower side, a variable resistance film 13, an upper electrode 14 of, for example Ta, and an interconnect layer 15 of, for example, tungsten or copper. The variable resistance film 13 may, for example, be a layered assembly composed of a lower layer of AlOₓ and an upper layer of HfOₓ. The variable resistance film 13 is electrically connected to the upper surface and to the sidewall surface of the second portion 11b of the lower electrode 11. The lower electrode 11, variable resistance film 13 and the upper electrode 14 make up the variable resistance element 3. The interconnect layer 15, which is to form the bit line (BL of FIG. 3 and BL0 to BL2 of FIG. 4), is electrically connected to a column decoder (36 of FIG. 3). Like the interconnect layer 15, which is to be the bit line, the variable resistance film 13 and the upper electrode 14 are each formed as a line. The layered assembly of the variable resistance film 13, upper electrode 14 and the interconnect layer 15 is planarized along the upper surface of the interlayer insulation film 18. A cover insulation film 16 of, for example, silicon oxide, is formed on top of the interlayer insulation film 18 and the layered assembly of the variable resistance film 13, upper electrode 14 and the interconnect layer 15.

Otherwise, the configuration as well as the operation of the subject exemplary embodiment is similar to those of exemplary embodiment 2.

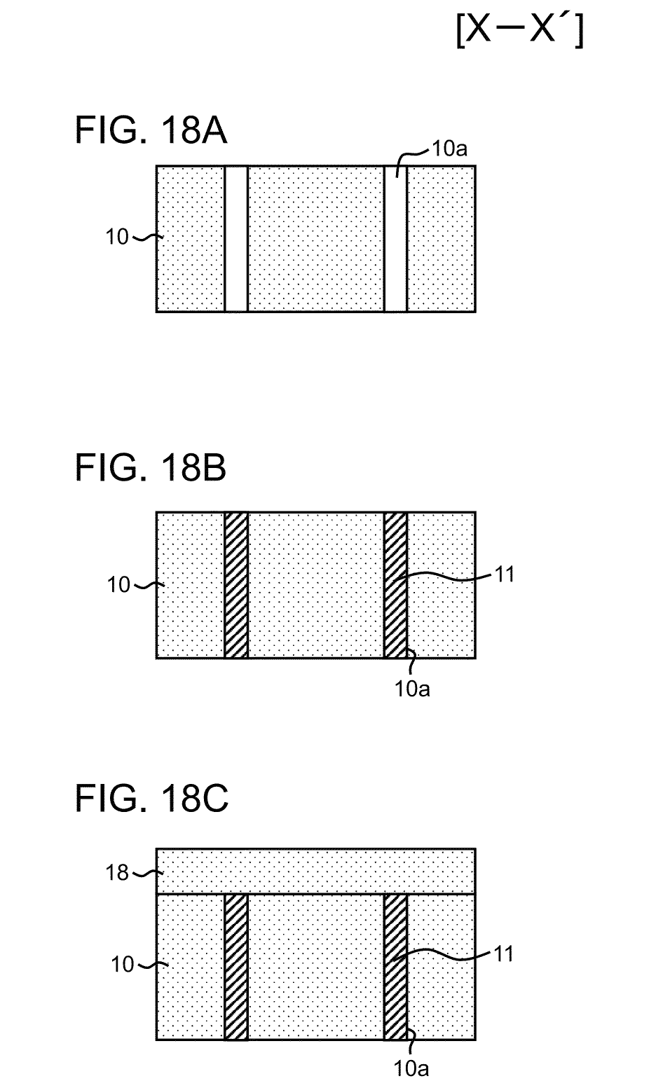

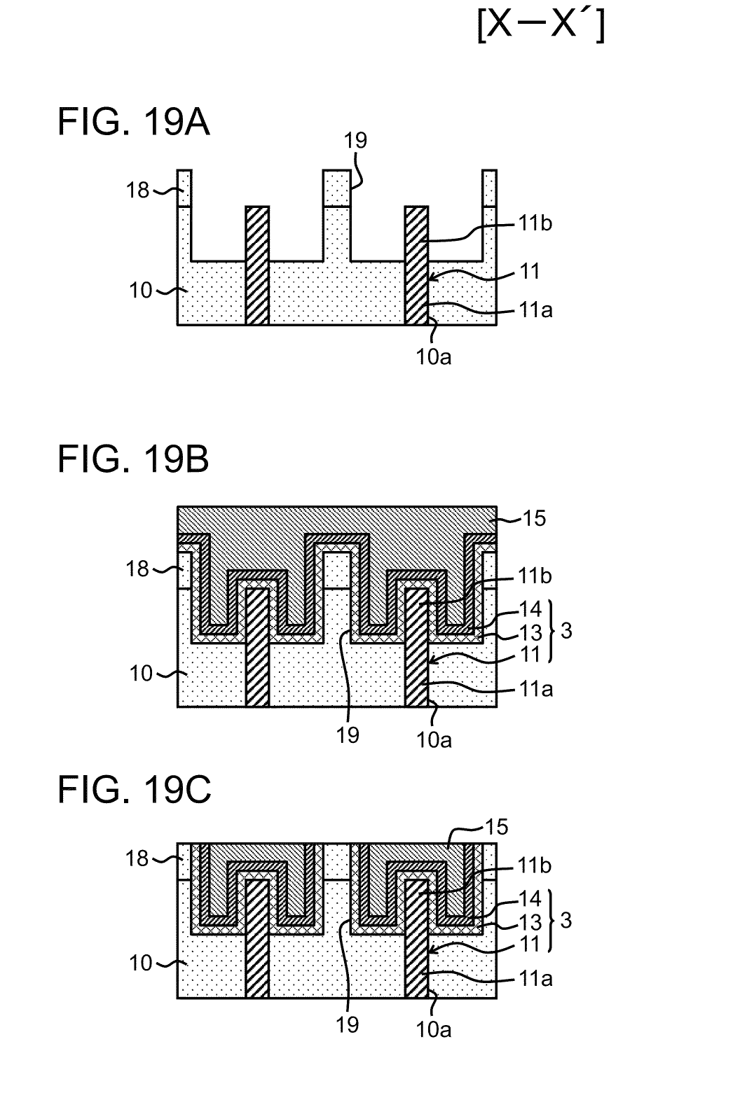

The manufacturing method of the variable resistance element according to the subject exemplary embodiment 3 will now be described with reference to the drawings. FIGS. 18A, 18B and 18C are cross-sectional views, taken along lines X-X′ of FIG. 16, schematically showing respective process steps of the manufacturing method for the variable resistance element according to exemplary embodiment 3. FIGS. 19A, 19B and 19C, are cross-sectional views schematically showing respective process steps, consecutive to those of FIGS. 18A, 18B and 18C, of the method for manufacturing the variable resistance element according to exemplary embodiment 3.

Initially, the interlayer insulation film 10 is deposited on the top of the layer of the MOS transistor (2 of FIG. 4), here not shown. Then, using the lithographic and etching techniques, the contact hole 10a is opened through the interlayer insulation film 10 in a step C1, see FIG. 18A. This contact hole is to communicate with a diffusion layer, not shown, which will form a source of the MOS transistor (2 of FIG. 4). It is noted that, should there be another interlayer insulation film subjacent to the interlayer insulation film 10, the contact hole is opened so that it will pass through the other interlayer insulation film as well.

The lower electrode 11 is then formed within the contact hole 10a in a step C2, see FIG. 18B. In forming the lower electrode 11, a TiN film may be deposited on the top of the interlayer insulation film 10, now including the contact hole 10a, and the so deposited TiN film is planarized by CMP (Chemical Mechanical Polishing) until the upper surface of the interlayer insulation film 10 is exposed.

The interlayer insulation film 18 is then formed in a step C3, on the top of the interlayer insulation film 10, now carrying the lower electrode 11, see FIG. 18C.

A trench 19 is then formed in a step C4 in the interlayer insulation films 10, 18 until the sidewall surface of the second portion 11b of the lower electrode 11 is exposed, see FIG. 19A. The trench 19 may be formed by selectively etching the interlayer insulation films 10, 18, using lithographic and etching techniques, so that the bottom surface of the trench 19 will be at a middle portion of the interlayer insulation film 10.

The variable resistance film 13, upper electrode 14 and the interconnect layer 15 are then formed on the top of the interlayer insulation film 18, now including the trench 19, and the second portion 11b of the lower electrode 11, in a step C5, see FIG. 19B.

The variable resistance film 13, upper electrode 14 and the interconnect layer 15 are then planarized in a step C6 by CMP until the interlayer insulation film 18 is exposed, see FIG. 19C.

Finally, the cover insulation film 16 is formed in a step C7 on the interlayer insulation film 18, the variable resistance film 13, upper electrode 14 and the interconnect layer 15, see FIG. 17. The cover insulation film 16 may be formed by depositing a silicon oxide film by CVD and subsequently planarizing the so deposited silicon oxide film by CMP.

In exemplary embodiment 3, the advantageous effect similar to that of exemplary embodiment 2 may be displayed. Moreover, by adjusting the depth of the trench 19 formed in the interlayer insulation films 10, 18, the sidewall surface of the second portion 11b of the lower electrode 11 can be exploited as a resistance variable region. Additionally, in exemplary embodiment 3, the length from the CMP worked surface to the resistance variable region of the variable resistance film 13 may be elongated in the up-and-down direction even if the design rule, specifically the line width, is reduced. Hence, the variable resistance portion and the CMP worked portion may be set apart a larger distance from each other. Furthermore, in exemplary embodiment 3, the area operating as the variable resistance region may be adjusted with much ease by adjusting the depth of the trench 19 formed in the interlayer insulation films 10, 18. Hence, a constant characteristic may be maintained, regardless of generations, with the characteristic of the variable resistance element 3 not being affected by difference in the process, material types or design rule comminution.

It is observed that symbols used for reference to the drawings are simply illustrations to assist in understanding and are not intended to limit the present invention to the modes illustrated.

### APPENDIX

A variable resistance element in one aspect includes an insulation film and a lower electrode equipped with a first portion surrounded by the insulation film and a columnar-shaped second portion protruded upwards from the first portion beyond an upper surface of the insulation film. The variable resistance element also includes a variable resistance film that covers a preset region of the insulation film, the present region including the lower electrode, and that is electrically connected to at least an upper surface of the second portion of the lower electrode. The variable resistance element also includes an upper electrode that covers the variable resistance film and that is electrically connected to the variable resistance film.

Preferably, the variable resistance element further comprises a sidewall insulation film that covers a sidewall surface of the second portion of the lower electrode. The variable resistance film covers the preset region of the insulation film, the present region including the lower electrode, and the sidewall insulation film.

In the variable resistance element preferably the variable resistance film is electrically connected to the sidewall surface of the second portion of the lower electrode as well.

In the variable resistance element, preferably the insulation film has a trench in the preset region. The variable resistance film covers the insulation film and the lower electrode within the trench.

In the variable resistance element, preferably the lower electrode is substantially cylindrical-columnar-shaped, and the height of the second portion is greater than the diameter of the lower electrode.

The particular exemplary embodiments or examples may be changed or adjusted within the gamut of the entire disclosure of the present invention, inclusive of claims and drawings, based on the fundamental technical concept of the invention. Moreover, a variety of combinations or selection of elements herein disclosed (elements of claims, examples or exemplary embodiments and drawings) may be made within the concept of the claims of the present invention. Viz., the present invention may include a variety of changes or corrections that may occur to those skilled in the art in accordance with the total disclosures inclusive of the claims and the drawings as well as the technical concept of the invention. In particular, it is to be understood that, as regards the ranges of numerical values set out herein, any arbitrary numerical figures or sub-ranges contained in the ranges are in fact specifically stated even in the absence of explicit statements.

What is claimed is:

1. A variable resistance element, comprising:
an insulation film;
a lower electrode including a first portion surrounded by the insulation film and a columnar-shaped second portion protruded from the first portion upwards beyond an upper surface of the insulation film;
a variable resistance film that covers a preset region of the insulation film, the present region including the lower electrode, and that is electrically connected to at least an upper surface of the second portion of the lower electrode; and
an upper electrode that covers the variable resistance film and that is electrically connected to the variable resistance film.

2. The variable resistance element according to claim 1, further comprising:
a sidewall insulation film that covers a sidewall surface of the second portion of the lower electrode, wherein,
the variable resistance film covers the preset region of the insulation film, the present region including the lower electrode, and the sidewall insulation film.

3. The variable resistance element according to claim 1, wherein,
the variable resistance film is electrically connected to the sidewall surface of the second portion of the lower electrode as well.

4. The variable resistance element according to claim 1, wherein,
the insulation film has a trench in the preset region;
the variable resistance film covers the insulation film and the lower electrode within the trench.

5. The variable resistance element according to claim 1, wherein,
the lower electrode is substantially cylindrical-columnar-shaped; and
the second portion has a height greater than a diameter of the lower electrode.

6. The variable resistance element according to claim 2, wherein,
the lower electrode is substantially cylindrical-columnar-shaped; and
the second portion has a height greater than a diameter of the lower electrode.

7. The variable resistance element according to claim 3, wherein,
the lower electrode is substantially cylindrical-columnar-shaped; and
the second portion has a height greater than a diameter of the lower electrode.

8. The variable resistance element according to claim 4, wherein,
the lower electrode is substantially cylindrical-columnar-shaped; and
second portion has a height greater than a diameter of the lower electrode.
